(19) United States
(12) Patent Application Publication
(10) Pub. No.: US 2013/0292434 A1
(43) Pub. Date: Nov. 7, 2013

(54) Clear pocket that attaches to an automobile steering wheel for holding electronic and non electronic items on the wheel

(71) Applicant: Paul Allen Wright, Bremerton, WA (US)

(72) Inventor: Paul Allen Wright, Bremerton, WA (US)

(21) Appl. No.: 13/461,784

(22) Filed: May 2, 2012

(51) Int. Cl. B60R 7/04

(52) U.S. Cl. 224/276

(57) ABSTRACT

A portable, foldable one piece device that attaches to an automobile steering wheel as a holder for a variety of electronic or non-electronic devices. A clear vinyl pocket can hold notebook computers, electronic reading devices, fire and police command boards, clipboards, books, newspapers, keeping them completely visible. The durable single piece, washable construction has no moving parts. It can be folded and easily stored on the visor of a vehicle. Hook and loop fastener is sewn to the device for added utility. Accessories can be added to these fasteners such as writing utensils, note pads, lights, pictures, or other personal or work related items. A small pocket is sewn alongside the larger clear pocket for storage as well. The device can be mounted to the passenger side dash with additional hook and loop fasteners. The device is not for use while the vehicle is operating.

### FIELD OF THE INVENTION

This invention relates to steering wheel supported devices that support other work and personal items for use when the vehicle is not in motion.

### BACKGROUND OF THE INVENTION

New technologies in computers and electronic reading devices have created flat touch screen designs. Invoice books, clip boards, police and fire command boards also have a flat surface for working that is most conveniently used when held up off the lap of the user. Previous steering wheel devices have created tables for laptop computer use and or storage pockets designed for storage and not for utility. While some previous designs are more suited for use as a table or full computer workstation, the storage devices have been, relatively large, complex, heavy and prone to malfunction.

Trends in the fire service are moving incident command to the interior of response vehicles. While most police and fire vehicles have computers installed in the vehicle, a need exists to organize command functions on a separate device. This invention meets the need of supporting many of the tools currently used to meet this function.

The following Patents have been identified as supporting devices for use on steering wheels. None were found to operate with the functionality, size, flexibility, and simplicity of the invention being currently described. U.S.20120080465A1 to Jae S. Son Apr. 5, 2012, U.S.20080257228A1 to Joel and Mary Jo Chisler Oct. 23, 2008, U.S.20070251963A1 to Chien-Hsing Lin Nov. 1, 2007, U.S.20060107878A1 to Michael Cassata May 25, 2006, U.S.20050193925A1 to James Wesolek Sep. 8, 2005, U.S. Pat. No. 7,017,878 to James Guo, Wendy Zang Mar. 28, 2006, U.S.20040083930A1 to Kyu Hyun Han May 6, 2004, U.S.20020194946A1 to Crystal Jackson Dec. 26, 2002, U.S. Pat. No. 6,050,201 to David k. Blanchard, James W. Blanchard Jr. Apr. 18, 2000, U.S. Pat. No. 5,385,283 to Yoshihiko Shioda Jan. 31, 1995, U.S. Pat. No. 5,193,777 to Eugene W. Faulstich, U.S. Pat. No. 5056822 to Henry H. Shim Oct. 15, 1991, U.S. Pat. No. 4,375,881 to Stephen A. Mitchell Mar. 8, 1983, U.S. Pat. No. 4,287,621 to Charles A. Kurtz Sep. 8, 1981, U.S. Pat. No. 4,243,249 to H. Calvin Goss Jan. 6, 1981, U.S. Pat. No. 2,810,221 to S. E. Reifsnyder Oct. 22, 1957, U.S. Pat. No. 8,079,312 Sep. 30, 2008, U.S.20060032410A1 Aug. 10, 2004, U.S. Pat. No. 7,093,545 Oct. 8, 2003, U.S.20040144196A1 Jan. 29, 2003, U.S. Pat. No. 6,494,148 Jul. 10, 2001, U.S. Pat. No. 6,457,421 May 23, 2001, U.S. Pat. No. 6,408,769 Feb. 5, 2001, U.S. Pat. No. 6,412,425 Dec. 12, 2000, U.S. Pat. No. 6,279,800 Mar. 22, 2000, U.S. Pat. No. 6,148,738 Sep. 13, 1999, U.S. Pat. No. 036,158 Aug. 28, 1998, U.S. Pat. No. 6,038,983 Aug. 25, 1997, U.S. Pat. No. 5,845,585 Jun. 19, 1997, U.S. Pat. No. 6,126,197 Apr. 24, 1997, U.S. Pat. No. 5,749,306 Nov. 26, 1996, U.S. Pat. No. 5,662,047 Sep. 23, 1996, U.S. Pat. No. 5,749,305 Jul. 16, 1996, U.S. Pat. No. 5,558,026 Sep. 12, 1994, U.S. Pat. 5,413,035 Sep. 13, 1993, U.S. Pat. No. 5,386,785 Jul. 22, 1992, U.S. Pat. No. 4,890,559 Jan. 17, 1989, U.S. Pat. No. 4,453,788 Jul. 16, 1981, U.S. Pat. No. 4,375,881 Jan. 23, 1981, U.S. Pat. No. 3,643,606 Jun. 25, 1970.

### BRIEF SUMMARY OF THE INVENTION

This invention will support a variety of work or personal items while attached to the steering wheel of a non -moving vehicle. The clear pocket allows for full viewing of the entire object being supported. This allows for reading and use of the touch screen and mouse pad functions of some devices.

The hook and loop feature allows for personalized applications of work or personal attachments. The hook and loop can also be used to support the invention from areas where there is no steering wheel present.

The lightweight, durable design lends itself to easy storage on the visor of the automobile or to be carried conveniently in a pocket or purse. It is fully washable. A small pocket sewn into the clear larger pocket would most commonly be used for a writing instrument or computer stylus.

### BRIEF DESCRIPTION OF THE DRAWINGS

FIG. 1 illustrates the front of the device lying flat on a surface displaying the working surface.

FIG. 2 illustrates the back of the device with the seams attaching the front conveyances.

FIG. 3 Illustrates the device deployed on a steering wheel.

FIG. 4, 5, 6 Illustrate the device folding up for storage.

### DETAILED DESCRIPTION OF THE PREFERRED EMBODIMENT

The present invention is described in such a manner that one skilled in the pertinent art will understand the utility and advantages offered by the present invention. The present invention is novel in its simplicity as well as its durability, absence of non flexible materials, and storage convenience.

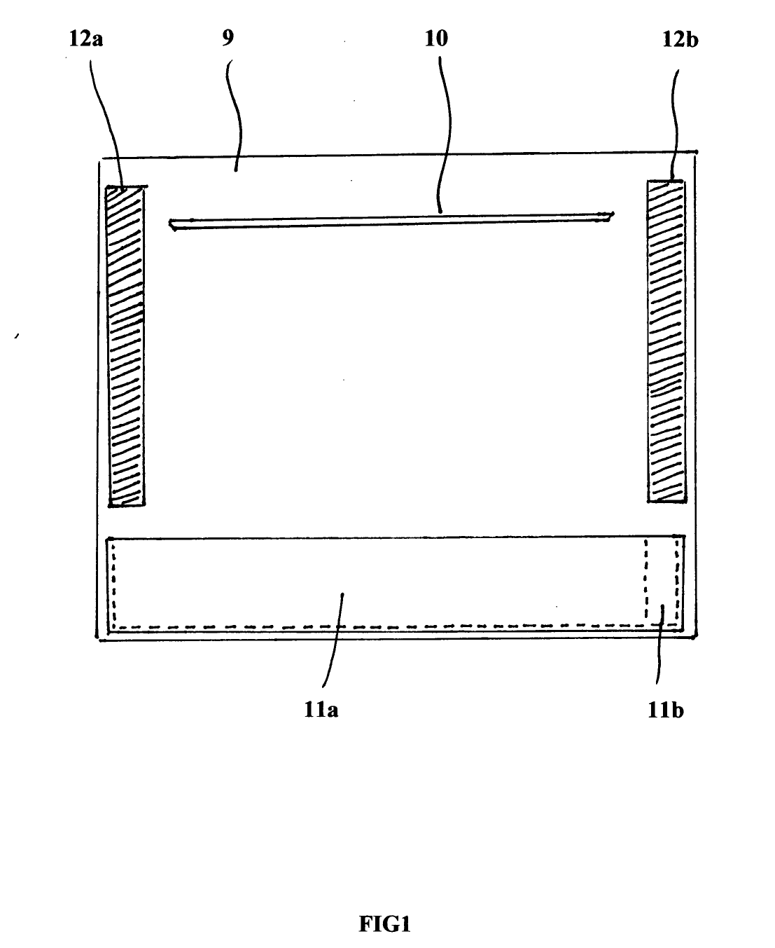

FIG. 1 displays the front or working side of the steering wheel pocket. The mounting opening (9) in the main body of the pocket slides over the top of the steering wheel and is supported by the steering wheel.

The material used for the main body of the pocket (10) has 80 pound rip strength and a very low stretch factor. It can also be made of a variety of non-tearing materials.

The clear pocket attachment (11a) provides a strong holding base for any object to be held to the steering wheel. The see through quality of the pocket allows for reading of materials placed into the pocket and manipulation of mouse pads, keyboards, and touch screen features.

The clear vinyl is stitched to create a smaller pocket (11b) for holding writing instruments, computer stylus, or any number of personalized accessories.

A strip of loop (12a, 12b) fastener runs along each side, left and right, to build in utility, personalization, alternate suspension methods, and specific storage for fire department command functions. The loop fastener is sewn on for durability and wash ability.

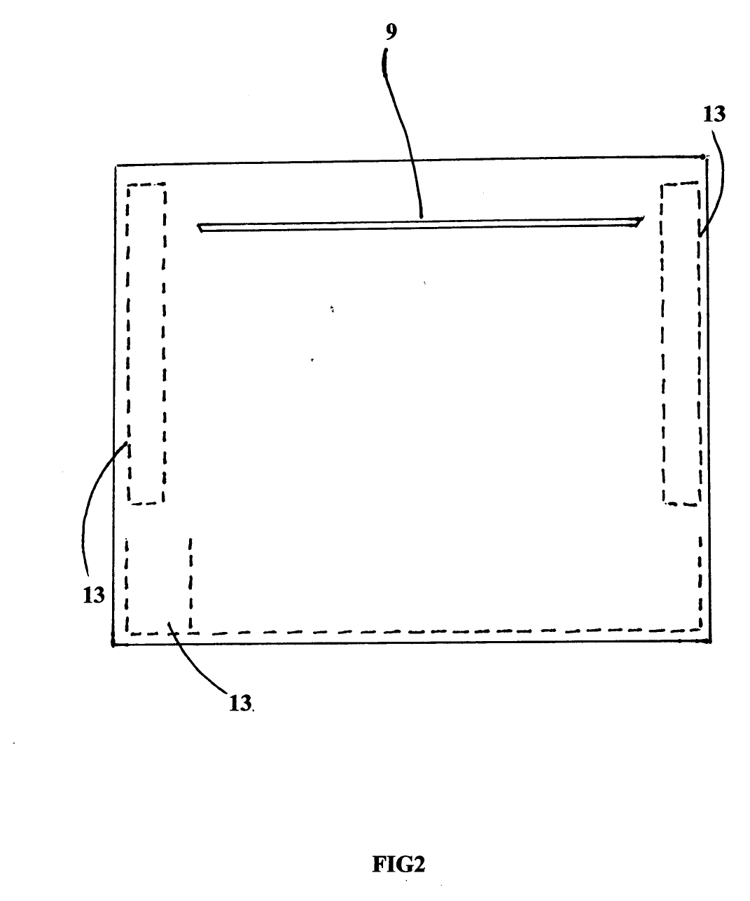

FIG. 2 This view displays the back (the part of the pocket that goes against the steering wheel) The mounting opening (9) is visible from the back. The stitching for 11a,11b,12a,12b is visible from the back (13).

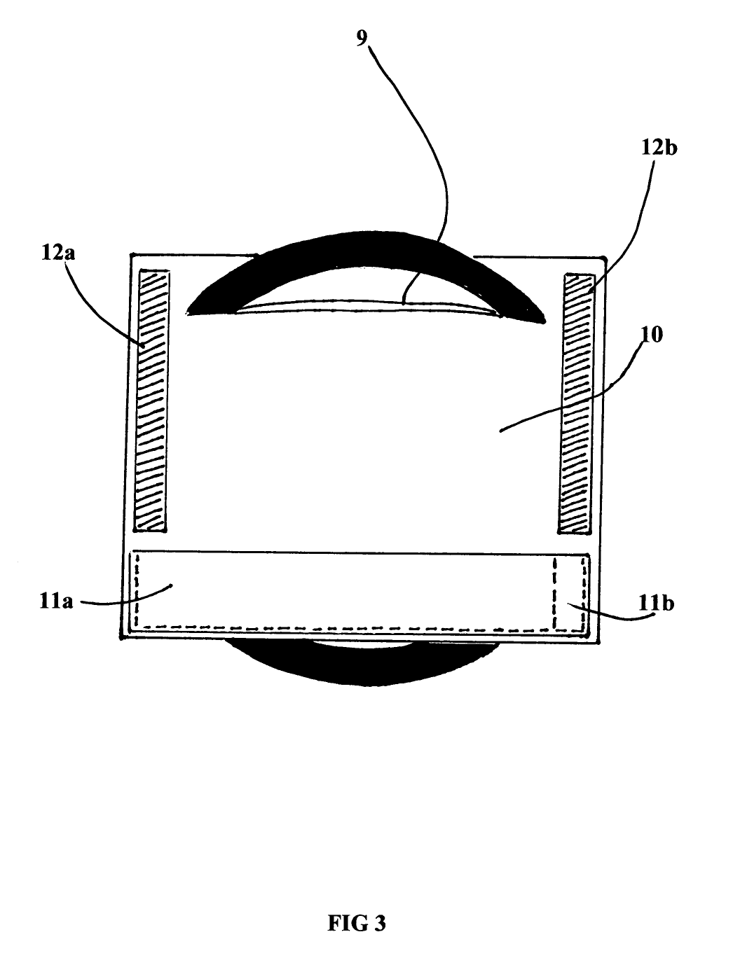

FIG. 3 This view displays the pocket deployed on a steering wheel in its functional form.

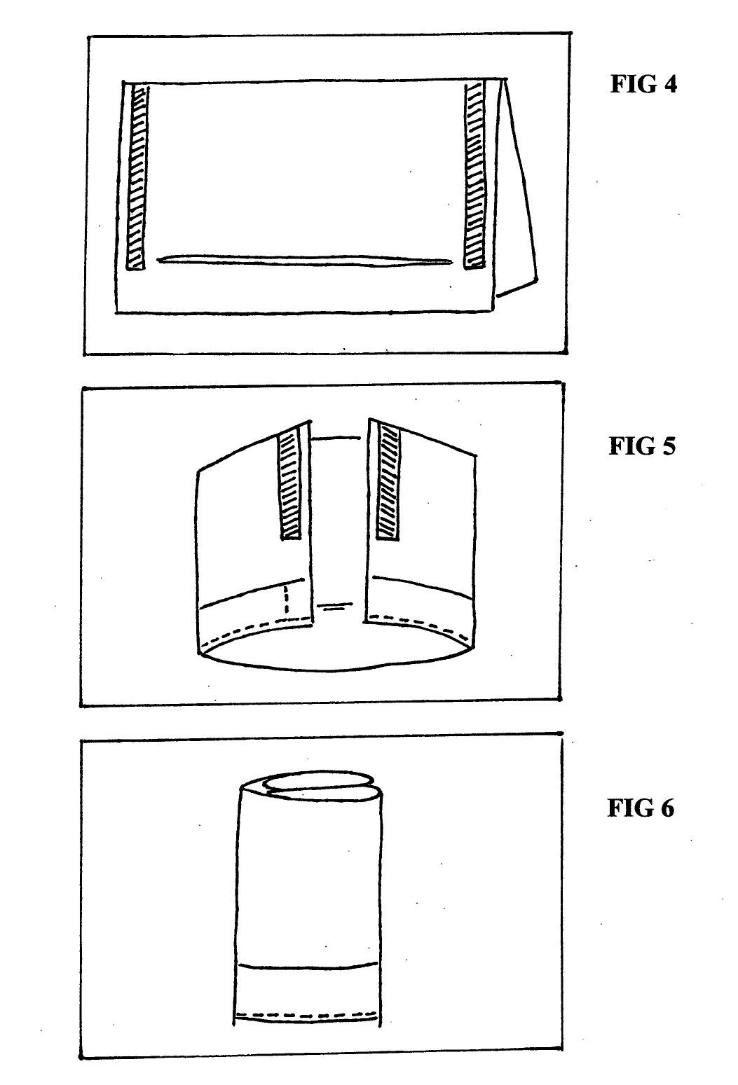

FIG. 4 This view shows the pocket first folding in half.

FIG. 5 This view shows the ends being folded in toward the middle.

FIG. 6 This view shows the present invention folded and ready for storage on the visor of the vehicle. There are no similar devices found that will compact to this size.

What is claimed is:

1. A steering wheel pocket for holding electronic and non electronic devices including notebook computers, electronic reading devices, books, police and fire command boards, clipboards, invoice books, and magazines on a steering wheel while the vehicle is not in motion.

2. The steering wheel pocket of claim has a clear pocket to keep the devices being held fully visible.

3. The steering wheel pocket of claim is Fully foldable, sturdy, wash able, single piece construction that can be stored in a pocket, purse, or on the visor of a vehicle.

4. The steering wheel pocket of claim can be easily transported from vehicle to vehicle, or to many other transport conveyances.

5. The steering wheel pocket of claim can be personalized with business or personal accessories using the loop fastener in conjunction with readily available stick on hook fastener.

6. The steering wheel pocket of claim can be deployed and/or put away in seconds.
